(19) United States
(12) Patent Application Publication
(10) Pub. No.: US 2010/0272466 A1
(43) Pub. Date: Oct. 28, 2010

(54) IMAGE FORMING APPARATUS, METHOD FOR INSTALLING IMAGE FORMING STRUCTURE AND METHOD FOR REMOVING IMAGE FORMING STRUCTURE

(76) Inventor: Kazuaki IIKURA, Saitama-shi (JP)

Correspondence Address: MORGAN LEWIS & BOCKIUS LLP, 1111 PENNSYLVANIA AVENUE NW, WASHINGTON, DC, 20004, US

(21) Appl. No.: 12/580,791

(22) Filed: Oct. 16, 2009

(30) Foreign Application Priority Data
Apr. 22, 2009 (JP) 2009-104202

(51) Int. Cl. G03G 15/00

(52) U.S. Cl. 399/110

(57) ABSTRACT

An image forming apparatus includes an image forming apparatus main body; an opening/closing part provided in the image forming apparatus main body; an image forming structure including an image holder that holds an image and an image holder covering member that moves between a protective position over the image holder and a moved-aside position beside the image holder, the image forming structure being installed and removed in/from the image forming apparatus main body through an open space which is opened by opening the opening/closing part; a displacement mechanism that moves the image holder covering member to the protective position in conjunction with opening of the opening/closing part and moves the image holder covering member to the moved-aside position in conjunction with closing of the opening/closing part; and a push mechanism that releases the image forming structure mechanically pushed and fit in the image forming apparatus main body in conjunction with opening of the opening/closing part and pushes the image forming structure to be fit in the image forming apparatus main body in conjunction with closing of the opening/closing part.

### CROSS-REFERENCE TO RELATED APPLICATIONS

This application is based on and claims priority under 35 USC 119 from Japanese Patent Application No. 2009-104202 filed Apr. 22, 2009.

### BACKGROUND

1. Technical Field

The present invention relates to an image forming apparatus, a method for installing an image forming structure, and a method for removing an image forming structure.

2. Summary

According to an aspect of the invention, there is provided an image forming apparatus including an image forming apparatus main body; an opening/closing part provided in the image forming apparatus main body; an image forming structure including an image holder that holds an image and an image holder covering member that moves between a protective position over the image holder and a moved-aside position beside the image holder, the image forming structure being installed and removed in/from the image forming apparatus main body through an open space which is opened by opening the opening/closing part; a displacement mechanism that moves the image holder covering member to the protective position in conjunction with opening of the opening/closing part and moves the image holder covering member to the moved-aside position in conjunction with closing of the opening/closing part; and a push mechanism that releases the image forming structure mechanically pushed and fit in the image forming apparatus main body in conjunction with opening of the opening/closing part and pushes the image forming structure to be fit in the image forming apparatus main body in conjunction with closing of the opening/closing part.

### BRIEF DESCRIPTION OF THE DRAWINGS

Exemplary embodiments of the present invention will be described in detail based on the following figures, wherein:

FIG. 1 is a perspective view showing an image forming apparatus in accordance with an exemplary embodiment of the invention;

FIG. 2 is a right-side, cross-sectional view of the image forming apparatus shown in FIG. 1;

FIG. 3 is a right side view of the apparatus, illustrating how a main opening/closing part is opened/closed with respect to the main body of the image forming apparatus shown in FIG. 1 and how photoreceptor units are installed in and removed from the main body.

FIG. 4 is a right-side, cross-sectional view of a photoreceptor unit employed in the image forming apparatus shown in FIG. 1;

FIG. 5 is a schematic plan view of the photoreceptor unit shown in FIG. 4;

FIGS. 6A and 6B illustrate movement of a shutter member included in a photoreceptor unit shown in FIG. 4, wherein FIG. 6A is a cross-sectional view in which the shutter member is positioned to protect the photoreceptor drum and FIG. 6B is a cross-sectional view in which the shutter member has been moved aside the photoreceptor drum.

FIG. 7 is a schematic plan view of the main body of the image forming apparatus shown in FIG. 1;

FIG. 8 is a right-side perspective view of a left positioning plate included in the image forming apparatus shown in FIG. 1;

FIG. 9 is a diagram representing a structure and functions of a linkage mechanism included in the image forming apparatus shown in FIG. 1;

FIG. 10 is a first perspective view of the linkage mechanism shown in FIG. 9;

FIG. 11 is a second perspective view of the linkage mechanism shown in FIG. 9;

FIGS. 12A to 12C illustrate movement of a rotating member and a moving member included in the linkage mechanism shown in FIG. 9, wherein FIG. 12A is a right side view which illustrates a state of the rotating member and the moving member when the opening/closing part is open, FIG. 12B is a right side view which illustrates a state of the rotating member and the moving member during closing of the opening/closing part, and FIG. 12C is a right side view which illustrates a state of the rotating member and the moving member when the opening/closing part is closed;

FIG. 13 is a first right side view which illustrates movement of a push protrusion and a push spring included in the linkage mechanism shown in FIG. 9;

FIG. 14 is a second right side view which illustrates movement of the push protrusion and the push spring included in the linkage mechanism shown in FIG. 9;

FIG. 15 is a flowchart illustrating a method for installing an image forming structure according to an exemplary embodiment of the invention; and

FIG. 16 is a flowchart illustrating a method for removing an image forming structure according to an exemplary embodiment of the invention.

### DETAILED DESCRIPTION

Exemplary embodiments of the present invention will now be described with reference to the drawings.

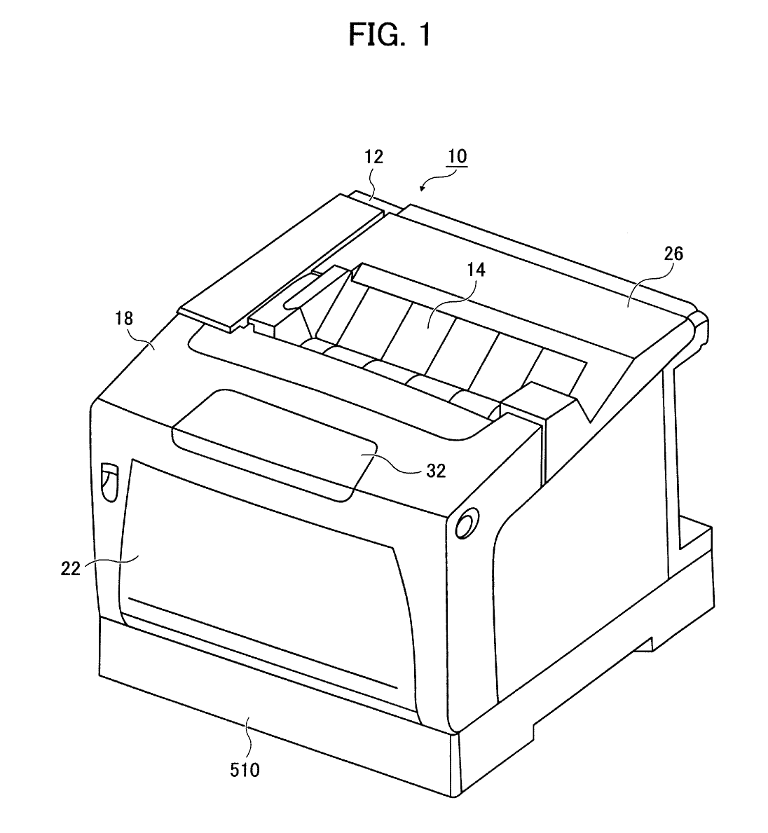

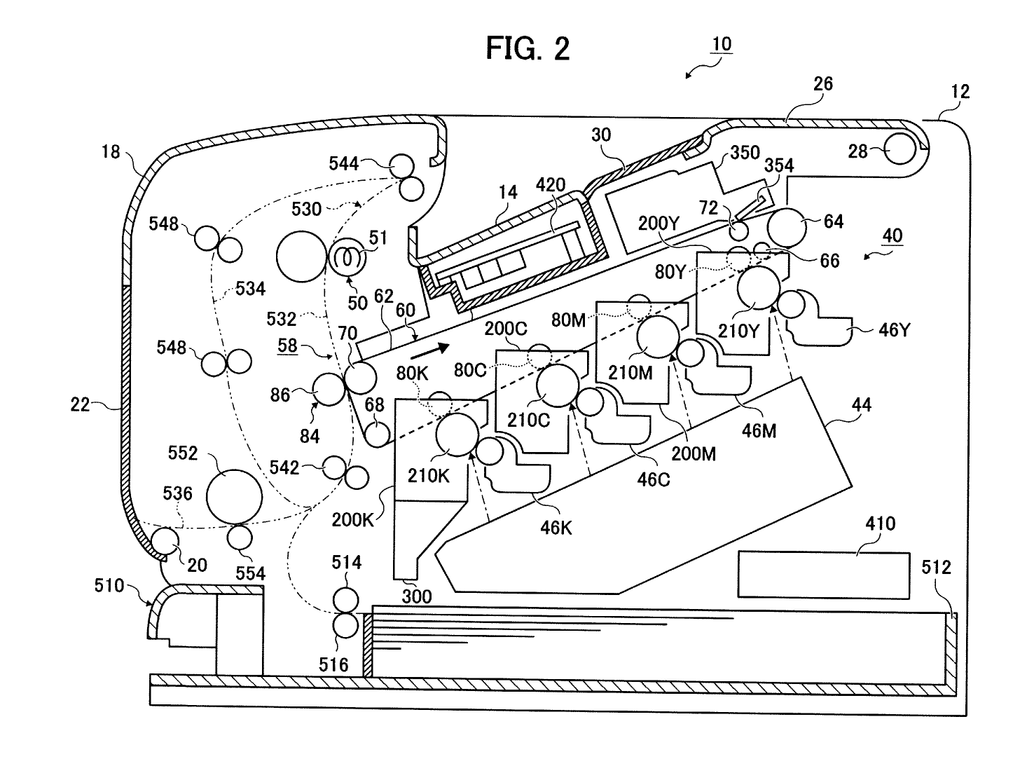

An image forming apparatus 10 in accordance with an exemplary embodiment of the invention is shown in FIG. 1 and FIG. 2. As can be seen in FIG. 1 and FIG. 2, the image forming apparatus 10 has an image forming apparatus main body 12.

A front opening/closing part 18 is hinged to the image forming apparatus main body 12 with hinges 20, so that it can be opened and closed with respect to the apparatus main body 12. Also, a main opening/closing part 26 which is used as the opening/closing part is hinged to the image forming apparatus main body 12 with hinges 28, so that it can be opened and closed with respect to the apparatus main body 12. An operator panel 32 is mounted in the front of the image forming apparatus main body 12.

The upper surface of the main opening/closing part 26 is used as, for example, a paper output part 14 to which paper having an image formed thereon is ejected.

An opening/closing part 22 for supply is mounted in the front opening/closing part 18, so that the section 22 can be opened and closed. The opening/closing part 22 for supply is usually closed with respect to the front opening/closing part 18, as shown in FIG. 1 and FIG. 2. The opening/closing part 22 for supply is opened with respect to the front opening/closing part 18, when the user wants to use sheets different from ones stored in a sheet feeder 510 which will be described later.

The main opening/closing part 26 is usually closed with respect to the image forming apparatus main body 12. The main opening/closing part 26 is opened for installing or removing at least one of photoreceptor units 200Y, 200M, 200C, 200B which will be described later in/from the image forming apparatus main body 12. In order to prevent that a support roller 70, an intermediate transfer belt 62, etc., which will be described later, assembled in the main opening/closing part 26 interfere with the front opening/closing part 18, the front opening/closing part 18 should be opened with respect to the image forming apparatus main body 12 before opening the main opening/closing part 26.

When closing the front opening/closing part 18 with respect to the image forming apparatus main body 12, the main opening/closing part 26 should be closed with respect to the image forming apparatus main body 12 before closing the front opening/closing part 18.

A secondary opening/closing part 30 is assembled in the main opening/closing part 26, so that it can be opened and closed with respect to the main opening/closing part 26. The secondary opening/closing part 30 can be opened and closed independently of the main opening/closing part 26; it can be opened while the main opening/closing part 26 is closed with respect to the image forming apparatus main body 12. The secondary opening/closing part 30 is opened for installing or removing the whole or a part of a developer remover 350 which will be described later in/from the image forming apparatus main body 12.

The operator panel 32 includes, for example, a numeric keypad which is used to enter the number of sheets which are subjected to image formation thereon, a start button which is pressed to start an image forming operation, and others.

Inside the image forming apparatus main body 12, an image forming part 40 is provided that forms an image on a sheet (a recording medium, paper). The image forming part 40 includes, for example, four photoreceptor units 200Y, 200M, 200C, 200K.

The photoreceptor units 200Y, 200M, 200C, 200K are respectively used as image forming structures and, respectively, have photoreceptor drums 210Y, 210M, 210C, 210K, each of which can be separately installed and removed in/from the image forming apparatus main body 12. The photoreceptor units 200Y, 200M, 200C, 200K are arranged in the order of a photoreceptor unit 200Y which is the first one, a second unit 200M, a third unit 200C, and the last unit 200K from the rear side (right side in FIG. 2) of the image forming apparatus main body 12. The photoreceptor units 200Y, 200M, 200C, 200K will be detailed later.

The photoreceptor drums 210Y, 210M, 210C, 210K are used as image holders that hold an image respectively.

The image forming part 40 also includes an optical projection device 44 which serves as a latent image forming device. The optical projection device 44 irradiates each of the photoreceptor drums 210Y, 210M, 210C, 210K with light and forms a latent image on the surface of each of the photoreceptor drums 210Y, 210M, 210C, 210K.

The image forming part 40 also includes development devices 46Y, 46M, 46C, 46K. The development device 46Y develops a latent image formed on the photoreceptor drum 210Y with a yellow toner stored therein. The development device 46M develops a latent image formed on the photoreceptor drum 210M with a magenta toner stored therein. The development device 46C develops a latent image formed on the photoreceptor drum 210C with a cyan toner stored therein. The development device 46K develops a latent image formed on the photoreceptor drum 210K with a black toner stored therein.

The image forming part 40 further includes a transfer device 58. The transfer device 58 includes an intermediate transfer belt unit 60 and a second transfer device 84. The intermediate transfer belt unit 60 includes an intermediate transfer belt 62.

The intermediate transfer belt 62 serves as an intermediate transfer body onto which images (toner images) are transferred from the photoreceptor drums 210Y, 210M, 210C, 210K. The intermediate transfer belt 62 is endless and lays across in a tensioned state on support rollers 64, 66, 68, 70, 72 so that it can rotate in a direction indicated by an arrow in FIG. 2. A driving force from, for example, a motor (not shown) is conveyed to a support roller 70 and, by its turning driven by the driving force, the support roller 70 conveys the driving force to the intermediate transfer belt 62.

The intermediate transfer belt unit 60 also includes first transfer rollers 80Y, 80M, 80C, 80K which are used as a first transfer device. The first transfer rollers 80Y, 80M, 80C, 80K transfer yellow, magenta, cyan, and black toner images respectively formed on the photoreceptor drums 210Y, 210M, 210C, 210K to the intermediate transfer belt 62.

The second transfer device 84 includes a second transfer roller 86. The second transfer roller 86 further transfers the yellow, magenta, cyan, and black toner images transferred to the intermediate transfer belt 62 onto a sheet.

The transfer device 58 includes a developer remover 350. The developer remover 350 includes a scraping member 354. A part of the developer remover 350 can be installed and removed in/from the image forming apparatus main body 12 through an opening provided by opening the secondary opening/closing part 30.

Among the members constituting the transfer device 58, the intermediate transfer belt unit 60 and the developer remover 350 are assembled in the main opening/closing part 26. Among the components of the transfer device 58, the second transfer roller 86 is fixed to the image forming apparatus main body 12. Moreover, the intermediate transfer belt 62 is disposed aslant such that its one end portion being in contact with the support roller 70, adjacent to the second transfer device 84, is positioned lower in the direction of gravitational force than its opposite end portion being in contact with the support roller 64.

Inside the image forming apparatus main body 12, furthermore, a fixing device 50 is provided that fixes a composite toner image transferred to a sheet by the second transfer roller 86 onto the sheet. The fixing device 50 includes a heater 51. The fixing device 50 fixes the composite developer image onto the sheet by pressing the developer image onto the sheet, while applying heat generated by the heater 51.

Inside the image forming apparatus main body 12, a waste toner receiver 300 is also provided. Deteriorated waste developer particles expelled from the development devices 46Y, 46M, 46C, 46K are collected into the waste toner receiver 300. The waste toner receiver 300 is, for example, integral with the photoreceptor unit 200K.

Inside the image forming apparatus main body 12, a sheet feeder 510 is installed to feed a sheet to the image forming part 40. The sheet feeder 510 can be pulled out from the front side (left side in FIG. 2) of the image forming apparatus main body 12, so that the sheet feeder 510 will be replenished with sheets after being pulled out of the image forming apparatus main body 12.

The sheet feeder 510 has a sheet container 512 which stocks a stack of sheets of, e.g., plain paper. The sheet feeder 510 includes a feed roller 514 which extracts a sheet at the top of the sheet stack stocked in the sheet container 512 and feeds the extracted sheet toward the image forming part 40. The sheet feeder 510 also includes a retard roller 516 to retard sheets which is used to prevent plural sheets clinging together from being fed.

Moreover, a transport path 530 that is used to transport a sheet is formed inside the image forming apparatus main body 12. The transport path 530 includes a main transport path 532, a reverse transport path 534, and a sub-transport path 536.

The main transport path 532 is used to transport a sheet fed from the sheet feeder 510 to the image forming part 40 and eject the sheet having an image formed thereon out of the image forming apparatus main body 12. Along the main transport path 532, the above-mentioned feed roller 514 and retard roller 516, registration rollers 542, the above-mentioned second transfer roller 86, the above-mentioned fixing device 50, and eject rollers 544 are disposed in the mentioned order from upstream in a direction in which a sheet is transported.

The registration rollers 542 temporarily stop the forward edge of a sheet fed from the sheet feeder 510 and transport the sheet toward the second transfer roller 86 so that the sheet will enter the rollers, namely, the second transfer roller 86 and the support roller 70, in time with timing when the toner images of each color have been transferred to the intermediate transfer belt 62.

The eject rollers 544 eject a sheet having the toners of each color fixed onto it by the fixing device 50 out of the image forming apparatus main body 12.

The reverse transport path 534 is a transport path which is used to turn over and supply again a sheet having a composite toner image fixed onto its one side toward the image forming part 40. Along the reverse transport path 534, for example, two pairs of reverse transport rollers 548 are disposed. In the reverse transport path 534, once the rear edge of a sheet have been nipped between the eject rollers 544, the sheet is supplied again, moved back by reverse rotation of the eject rollers 544, i.e., its rear edge goes ahead, and the supplied sheet is transported by the reverse transport rollers 548 to a position upstream of the registration rollers 542.

The sub-transport path 536 is a transport path to supply a different sheet from the sheets stored in the sheet feeder 510 to the image forming part 40. With the opening/closing part 22 for supply being open, a sheet is supplied to the sub-transport path 536 from the front side of the image forming apparatus main body 12. Along the sub-transport path 536, a transport roller 522 and a retard roller 554 are provided. The transport roller 522 transports a sheet supplied to the sub-transport path 536 toward the image forming part 40. The retard roller 554 is used to retard sheets supplied to the sub-transport path 536 and prevent plural sheets clinging together from being transported to the image forming part 40.

Inside the image forming apparatus main body 12, a first power supply unit 410 and a second power supply unit 420 are also provided.

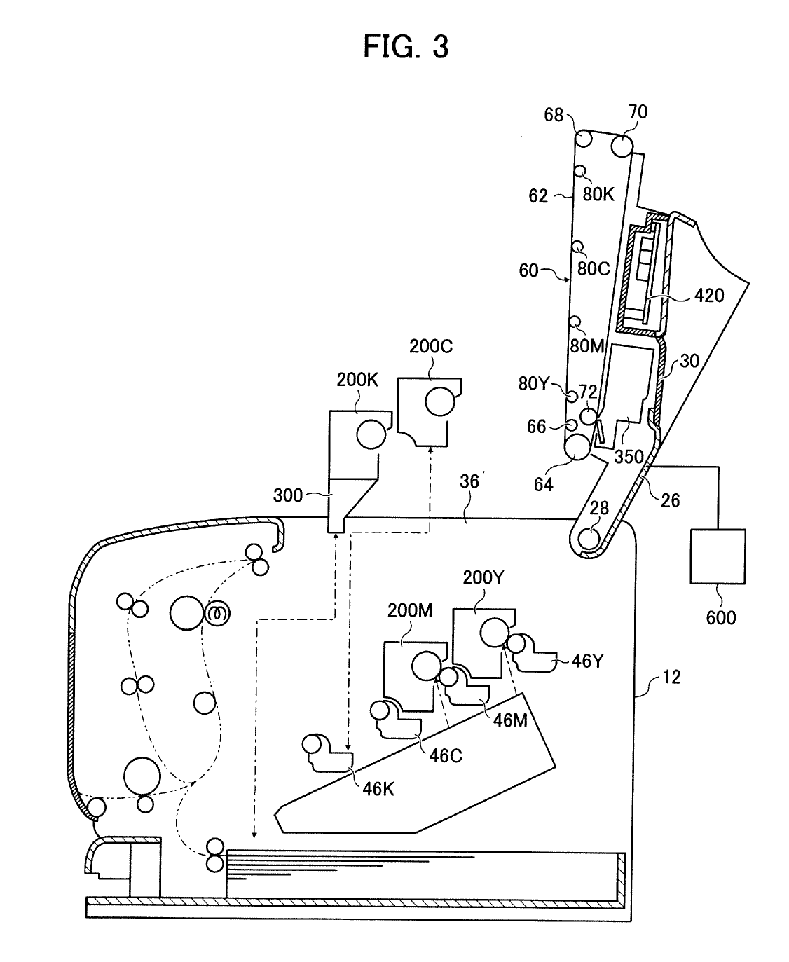

FIG. 3 illustrates how the main opening/closing part 26 is opened/closed with respect to the image forming apparatus main body 12 and how the photoreceptor units 200 are installed in and removed from the image forming apparatus main body 12.

As shown in FIG. 3, when the main opening/closing part 26 is opened with respect to the image forming apparatus main body 12, the intermediate transfer belt unit 60 and the developer remover 350 in the transfer device 58 as well as the second power supply unit 420 are displaced together with the main opening/closing part 26. That is, the intermediate transfer belt unit 60, the developer remover 350, and the second power supply unit 420 are opened and closed as an assembly in the main opening/closing part 26 with respect to the image forming apparatus main body 12.

When the main opening/closing part 26, the intermediate transfer belt unit 60, the developer remover 350, and the second power supply unit 420 are opened with respect to the image forming apparatus main body 12, an open space 36 defined inside the image forming apparatus main body 12 is made open. Through the open space 36, each of the photoreceptor units 200Y, 200M, 200C, 200K is installed in and removed from the image forming apparatus main body 12. The waste toner receiver 300 is integral with the photoreceptor unit 200 K, as already mentioned. Therefore, the waste toner receiver 300 is installed and removed integrally with the photoreceptor unit 200 K in/from the image forming apparatus main body 12.

The main opening/closing part 26 can be connected to a linkage mechanism 600. The linkage mechanism 600 serves as a displacement mechanism as well as a push mechanism. The linkage mechanism 600 will be detailed later.

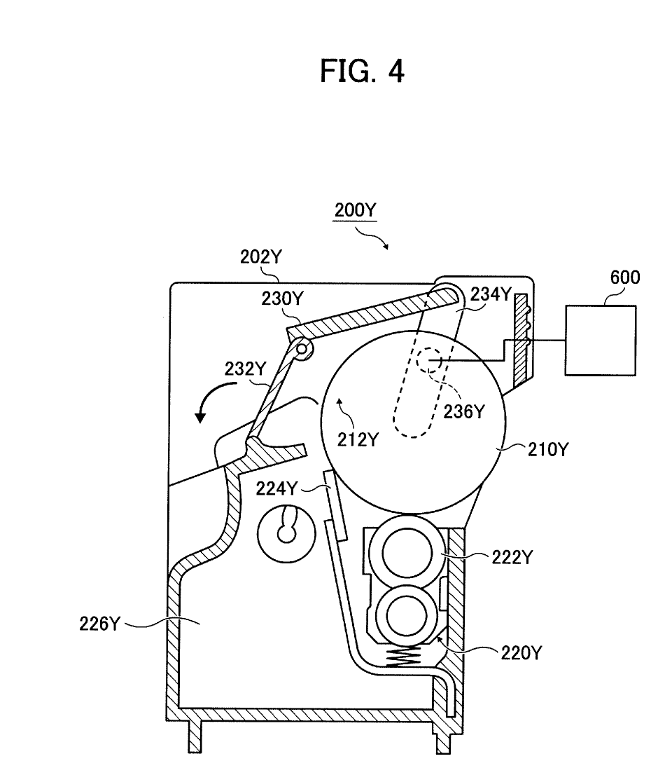

FIG. 4 is a cross-sectional view of the photoreceptor unit 200Y. Since the photoreceptor units 200M, 200C, 200K have the same structure as the photoreceptor unit 200Y, though they use developer of different colors, a description is only provided for the photoreceptor unit 200Y in the following paragraphs and descriptions on the photoreceptor units 200M, 200C, 200K are omitted.

As shown in FIG. 4, the photoreceptor unit 200Y has a photoreceptor unit main body 202Y and the above-mentioned photoreceptor drum 210Y is installed in the photoreceptor unit main body 202Y. A part of the photoreceptor drum 210Y is exposed outside the photoreceptor unit main body 202Y as an exposed portion 212Y. The photoreceptor unit main body 202Y serves as a housing in which the photoreceptor drum 210Y is installed with a part of the drum being exposed.

Inside the photoreceptor unit main body 202Y, a charging device 220Y which evenly charges the surface of the photoreceptor drum 210Y is installed. The charging device 220Y includes a charging roller 222Y contacting with the photoreceptor drum 210Y. Onto the surface of the photoreceptor drum 210Y evenly charged by the charging device 220Y evenly, a latent image is projected by the optical projection device 44 (see FIG. 1).

Inside the photoreceptor unit main body 202Y, further, a scraping member 224Y which serves as a cleaning device is installed. The scraping member 224Y scrapes off yellow toner particles remaining on the surface of the photoreceptor drum 210Y after a yellow toner image has been transferred to the intermediate transfer belt 62 by the first transfer roller 80Y (see FIG. 1).

Inside the photoreceptor unit main body 202Y, there is also a waste toner chamber 226Y where yellow toner particles scraped off by the scraping member 224 from the surface of the photoreceptor drum 210Y are collected.

Further, the photoreceptor unit 200Y includes a shutter member 230Y serving as a covering member for the image holder. The shutter member 230Y to which a support member 232Y and a pushed member 234 are connected is installed in the photoreceptor unit main body 202Y and can be displaced with respect to the photoreceptor unit 200Y.

One end of the support member 232Y is rotatably connected to one end of the shutter member 230Y and the other end of the support member 232Y is rotatably connected to the photoreceptor unit main body 202Y.

One end of the pushed member 234Y is rotatably linked to the other end of the shutter member 230Y, that is, the end which is opposite to the end to which the support member 232Y is connected. The other end of the pushed member 234Y is linked to and rotatable around a position corresponding to the center of rotation of the photoreceptor drum 210Y in the photoreceptor unit main body 202Y. A pushed protrusion 236 serving as a portion to be pushed is formed on the left side of the pushed member 234Y. The above-mentioned linkage mechanism 600 (see FIG. 3) can be connected to the pushed protrusion 236.

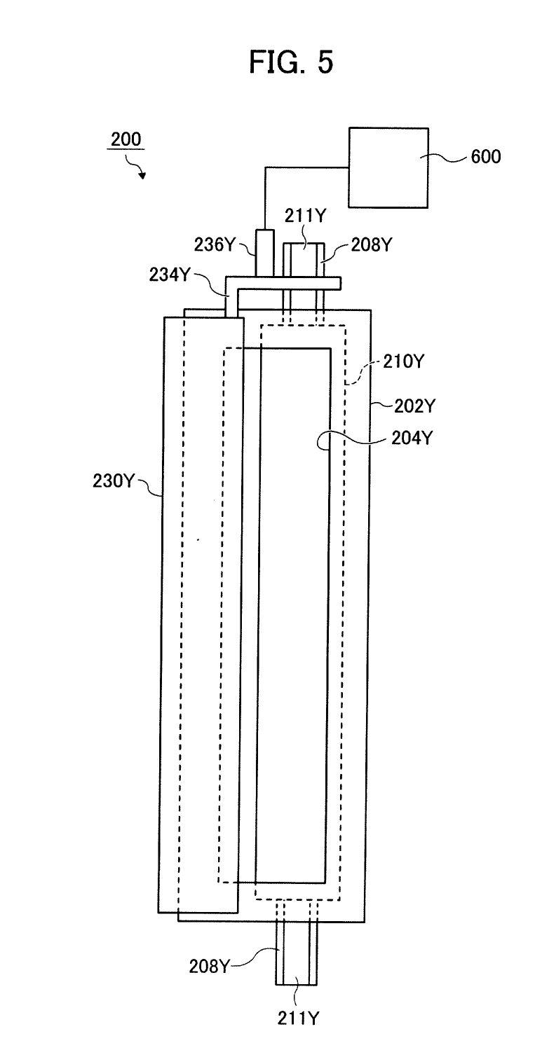

FIG. 5 is a schematic plan view of the photoreceptor unit 200Y.

As shown in FIG. 5, an opening 204Y is formed in the upper surface of the photoreceptor unit main body 202Y. Through the opening 204Y, a part of the photoreceptor drum 210Y is exposed outside the photoreceptor unit main body 202Y.

Also as shown in FIG. 5, the photoreceptor drum 210Y is rotatably installed in the photoreceptor unit main body 202Y by means of bearings 208Y. More specifically, the portions 211Y of the shaft protruded from both longitudinal ends of the photoreceptor drum 210Y are rotatably supported on the bearings 208Y and the bearings 208Y are fixed to the photoreceptor unit main body 202Y.

As described above, the pushed protrusion 236Y is formed on the left side (at the top in FIG. 5) of the pushed member 234Y connected to the shutter member 230 and the linkage mechanism 600 can be connected to the pushed protrusion 236Y. When the shutter member 230 covers the opening 204Y of the photoreceptor drum 210Y, the pushed protrusion 236Y and the shaft portion 211Y are disposed to overlap each other as viewed from above. When the photoreceptor unit 200Y is lifted up and down through the open space 36 for removal from or installation in the image forming apparatus main body 12, the shaft portion 211Y and the pushed protrusion 236Y are guided into and fit in a main notch 116Y provided in a left attachment plate 114 which will be described later.

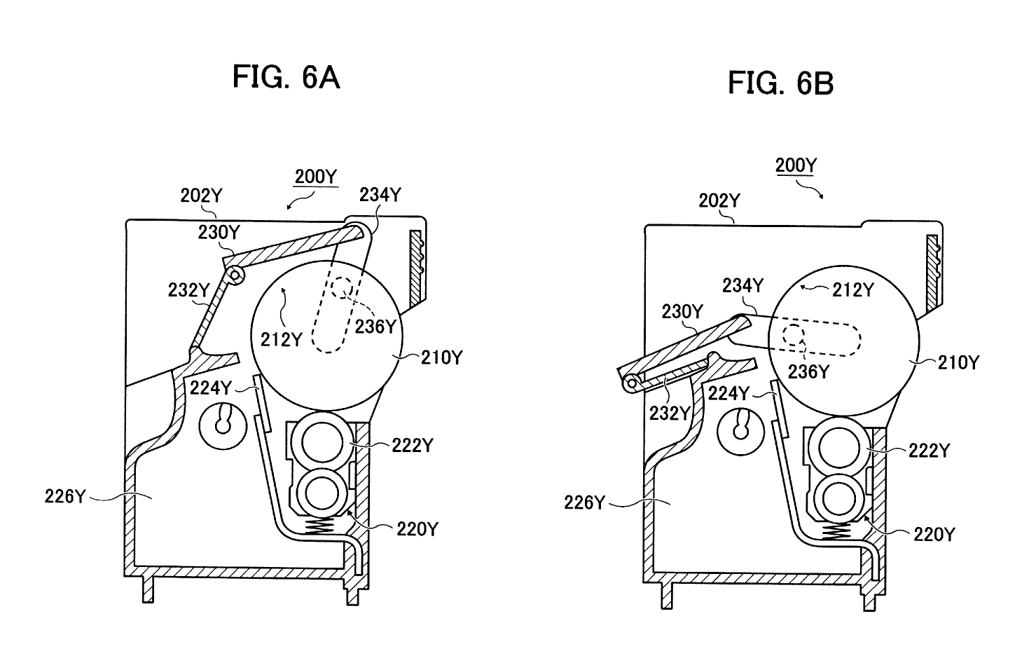

FIGS. 6A and 6B illustrate movement of the shutter member 230Y. The shutter member 230Y moves between a position shown in FIG. 6A as a protective position and a position shown in FIG. 6B as a moved-aside position. In the protective position shown in FIG. 6A, the shutter member 230Y covers the exposed portion 212 of the photoreceptor drum 210Y and protects the photoreceptor drum 210Y. In the moved-aside position shown in FIG. 6B, the shutter member 230Y has been moved aside the photoreceptor drum 210Y and the exposed portion 212Y is exposed out of the photoreceptor unit main body 202Y.

An urging member (not shown) formed of, e.g., a coil spring or the like is attached to any of the shutter member 230Y, the support member 232Y, and the pushed member 234Y. By this attached member, the shutter member 230Y is urged to be positioned in the protective position shown in FIG. 6A.

In a state where the photoreceptor unit 200Y has been removed from the image forming apparatus main body 12, the shutter member 230Y stays in the protective position shown in FIG. 6A. The photoreceptor drum 210Y is thus protected in the state where the photoreceptor unit 200Y has been removed from the image forming apparatus main body 12. After the photoreceptor unit 200Y is installed in the image forming apparatus main body 12, when the main opening/closing part 26 is still open with respect to the image forming apparatus main body 12, the shutter member 230Y also stays in the protective position shown in FIG. 6A. The photoreceptor drum 210Y is thus protected in the state where the main opening/closing part 26 is open.

However, after the photoreceptor unit 200Y is installed in the image forming apparatus main body 12, when the main opening/closing part 26 is closed with respect to the image forming apparatus main body 12, the shutter member 230Y is displaced to the moved-aside position shown in FIG. 6B. This makes the exposed portion 212Y of the photoreceptor drum 210Y exposed, so that the photoreceptor drum 210Y can be used for image formation.

Movement of the shutter member 230Y between the protective position and the moved aside position takes place in conjunction with opening and closing of the main opening/closing part 26 with respect to the image forming apparatus main body 12. That is, the main opening/closing part 26 and the shutter member 230Y are connected via the above-mentioned linkage mechanism 600, thereby resulting in that the shutter member 230Y moves from the moved-aside position to the protective position in conjunction with opening of the main opening/closing part 26. The connection of the main opening/closing part 26 and the shutter member 230Y via the linkage mechanism 600 also results in that the shutter member 230Y moves from the protective position to the moved-aside position in conjunction with closing of the main opening/closing part 26.

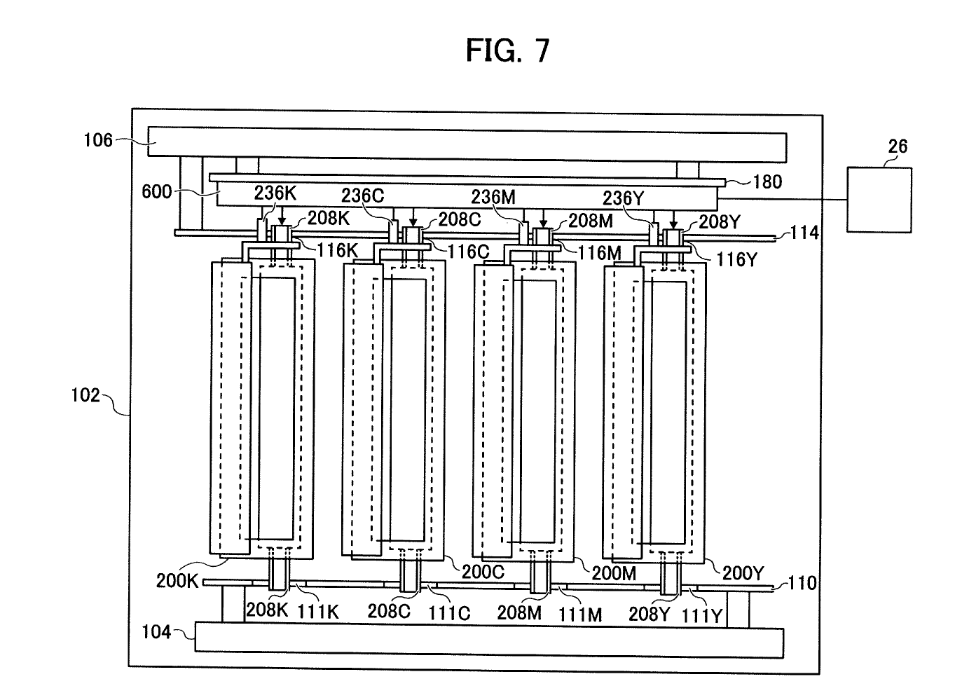

FIG. 7 is a schematic plan view of the image forming apparatus main body 12.

As can be seen in FIG. 7, the image forming apparatus main body 12 has a base 102 and a right frame 104 and a left frame 106 are mounted on the base so as to be substantially vertical to the upper surface of the base. A right attachment plate 110 is fixed to the right frame 104. A left attachment plate 114 and a linkage mechanism support plate 180 are fixed to the left frame 106. The right attachment plate 110 and the left attachment plate 114 serve as brackets for the plural photoreceptor units 200 (photoreceptor units 200Y, 200M, 200C, 200K) to be pushed and fit therein.

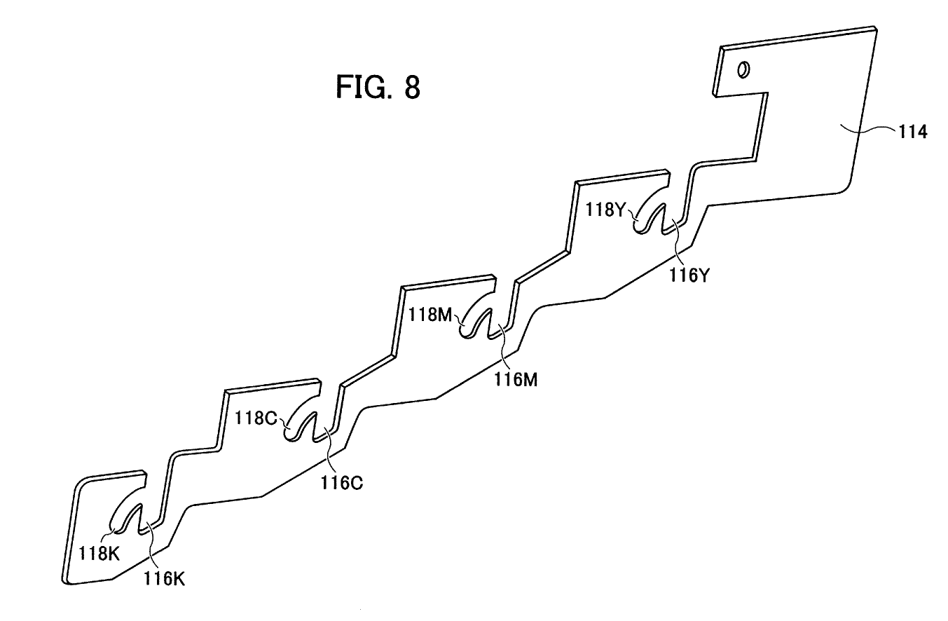

The right attachment plate 110 and the left attachment plate 114 are used to install the photoreceptor units 200Y, 200M, 200C, 200K. Notches 111Y, 111M, 111C, 111K are formed in the right attachment plate 110 from its upper end toward the lower end. Main notches 116Y, 116M, 116C, 116K are formed in the left attachment plate 114 from its upper end toward the lower end (see FIG. 8). Bearings 208Y, 208M, 208C, 208K protruded from the right ends of the photoreceptor units 200Y, 200M, 200C, 200K are inserted in and supported by the notches 111Y, 111M, 111C, 111K. Also, the bearings 208Y, 208M, 208C, 208K protruded from the left ends of the photoreceptor units 200Y, 200M, 200C, 200K are supported by the main notches 116Y, 116M, 116C, 116K.

The linkage mechanism 600 is supported by the linkage mechanism support plate 180. As already noted, the linkage mechanism 600 can be connected to the main opening/closing part 26 and can be connected to the pushed protrusions 236Y, 236M, 236C, 236K, separately. By the linkage mechanism 600, the photoreceptor units 200Y, 200M, 200C, 200K can separately be pushed and fit in the left attachment plate 114 and can be positioned in the left attachment plate 114. More specifically, the bearings 208Y, 208M, 208C, 208K respectively protruded from the left ends of the photoreceptor units 200Y, 200M, 200C, 200K are pushed and fit in the left attachment plate 114 by the linkage mechanism 600. Thereby, the photoreceptor drums 210Y, 210M, 210C, 210K are pushed and fit with respect to the left attachment plate 114 and positioned with respect to the left attachment plate 114.

The bearings 208Y, 208M, 208C, 208K respectively protruded from the right ends of the photoreceptor units 200Y, 200M, 200C, 200K are pushed and fit in the right attachment plate 110 and positioned in the right attachment plate 110.

The left attachment plate 114 is shown in FIG. 8.

As already mentioned, the main notches 116Y, 116M, 116C, 116K are formed in the left attachment plate 114. In the left attachment plate 114, arc-shaped branch notches 118Y, 118M, 118C, 118K are also formed, respectively branching from the main notches 116Y, 116M, 116C, 116K.

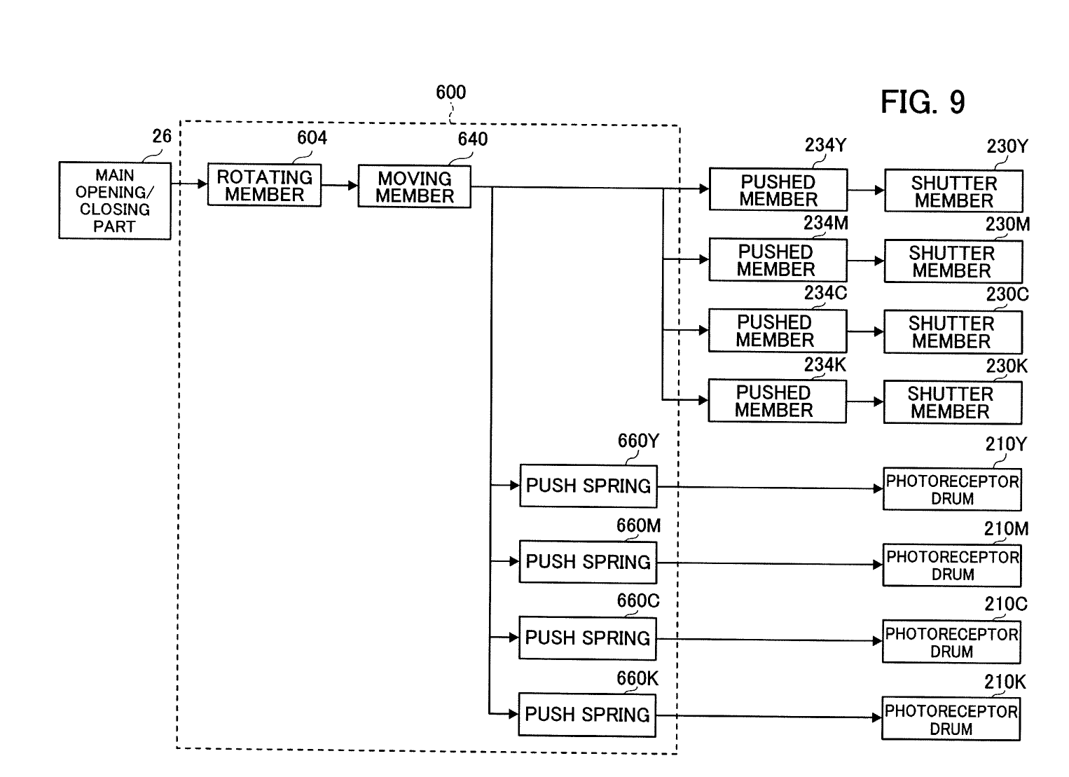

The structure and functions of the linkage mechanism 600 are diagrammatically represented in FIG. 9.

The linkage mechanism 600 includes a rotating member 604, a moving member 640, and springs 660Y, 660M, 660C, 660K as spring members producing a pushing force and having a spring property. Movement of the main opening/closing part 26 is transferred to the rotating member 604 and movement of the rotating member 604 is transferred to the moving member 640, thereby displacing the moving member 640 and the springs 660Y, 660M, 660C, 660K. The moving member 640 moves and pushes the pushed protrusions 236Y, 236M, 236C, 236K of the pushed members 234Y, 234M, 234C, 234K (see FIG. 4). By being pushed, the pushed members 234Y, 234M, 234C, 234K move, respectively. By the movement of the pushed members 234Y, 234M, 234C, 234K, the shutter members 230Y, 230M, 230C, 230K move, respectively.

The springs 660Y, 660M, 660C, 660K are used to push and fit the photoreceptor drums 210Y, 210M, 210C, 210K in the right attachment plate 110 and left attachment plate 114, respectively. These springs move with the moving member 640 and push and fit the photoreceptor drums 210Y, 210M, 210C, 210K in the right attachment plate 110 and the left attachment plate 114, respectively.

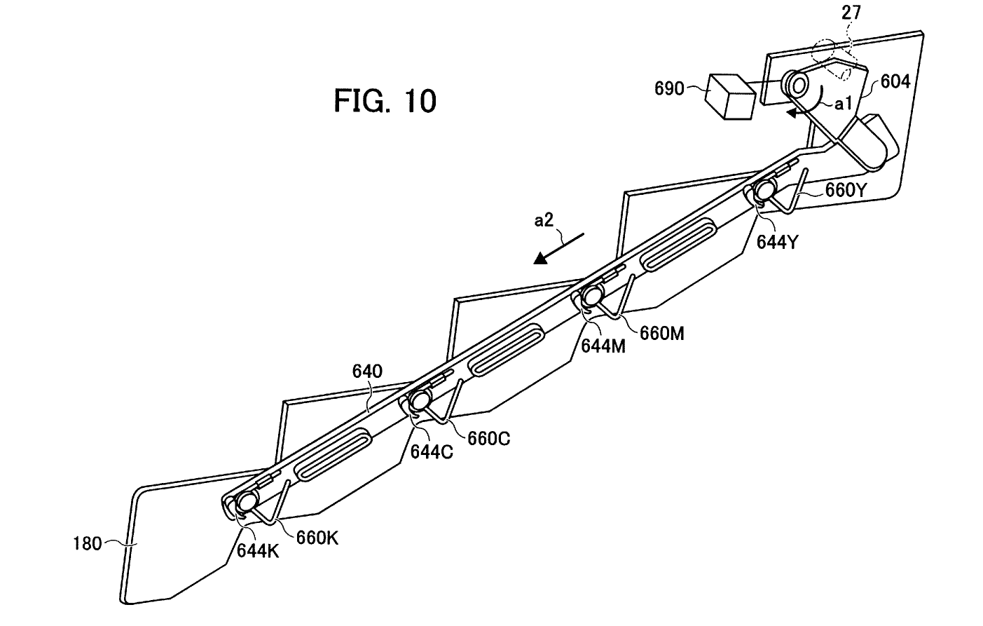

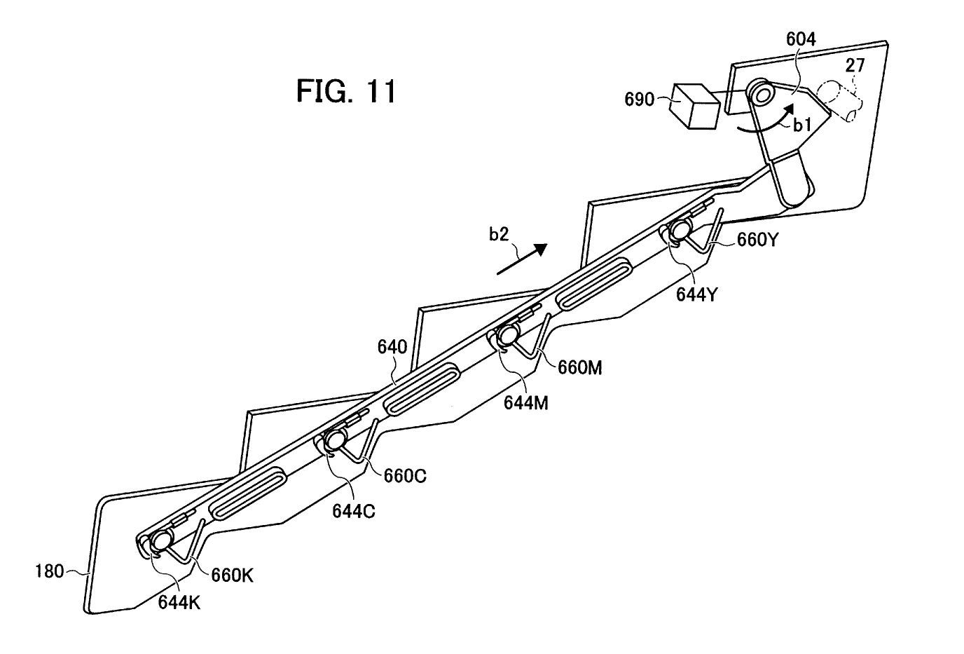

The linkage mechanism 600 is shown in FIG. 10 and FIG. 11.

The linkage mechanism 600 includes the rotating member 604 and the moving member 640, as described above. The rotating member 604 is fixed to the linkage mechanism support plate 180 such that it can rotate in a direction of arrow a1 as shown in FIG. 10 and in a direction of arrow b1 as shown in FIG. 11. An urging member 690 is fixed to the rotating member 604; as the urging member 690, e.g., a torsion spring, a coil spring, etc. may be used. By the urging member 690, the rotating member 604 is urged to rotate in the direction of arrow b1.

A push portion 27 provided in the main opening/closing part 26 (see FIG. 3) contacts with the rotating member 604. When the rotating member 604 is pushed by the push portion 27, the rotating member 604 rotates in the direction of arrow a1 against the urging force of the urging member 690. More specifically, when the main opening/closing part 26 is closed with respect to the image forming apparatus main body 12, the rotating member 604 rotates in the direction of arrow a1 by being pushed by the push portion 27. When the main opening/closing part 26 is opened with respect to the image forming apparatus main body 12, the rotating member 604 rotates in the direction of arrow b1 by being urged by the urging member 690.

The moving member 640 is connected to the rotating member 604 and can move with respect to the linkage mechanism support plate 180 in a direction of arrow a2 as shown in FIG. 10 and in a direction of arrow b2 as shown in FIG. 11. More specifically, closing of the main opening/closing part 26 with respect to the image forming apparatus main body 12 causes the rotating member 604 to rotate in the direction of arrow a1 and, in conjunction with the rotation of the rotating member 604 in the direction of arrow a1, the moving member 640 moves in the direction of arrow a2. Opening of the main opening/closing part 26 with respect to the image forming apparatus main body 12 causes the rotating member 604 to rotate in the direction of arrow b1 and, in conjunction with the rotation of the rotating member 604 in the direction of arrow b1, the moving member 640 moves in the direction of arrow b2.

As already mentioned, the springs 660Y, 660M, 660C, 660K are fixed to the moving member 640. Each of the springs 660Y, 660M, 660C, 660K is formed of a coil spring, a part of which protrudes downward from the moving member 640. As already noted, each of the springs 660Y, 660M, 660C, 660K has a function of pushing and fitting the corresponding one of the photoreceptor drum 210Y, 210M, 210C, 210K in the left attachment plate 114.

Push protrusions 644Y, 644M, 644C, 644K, protruding toward the right (inward of the image forming apparatus main body 12), are formed in the moving member 640. The push protrusions 644Y, 644M, 644C, 644K are arranged to push the pushed protrusion 236Y formed in the pushed member 234Y (see FIG. 4) and pushed protrusions 236M, 236C, 236Y similarly formed in pushed members 234M, 234C, 234Y, respectively.

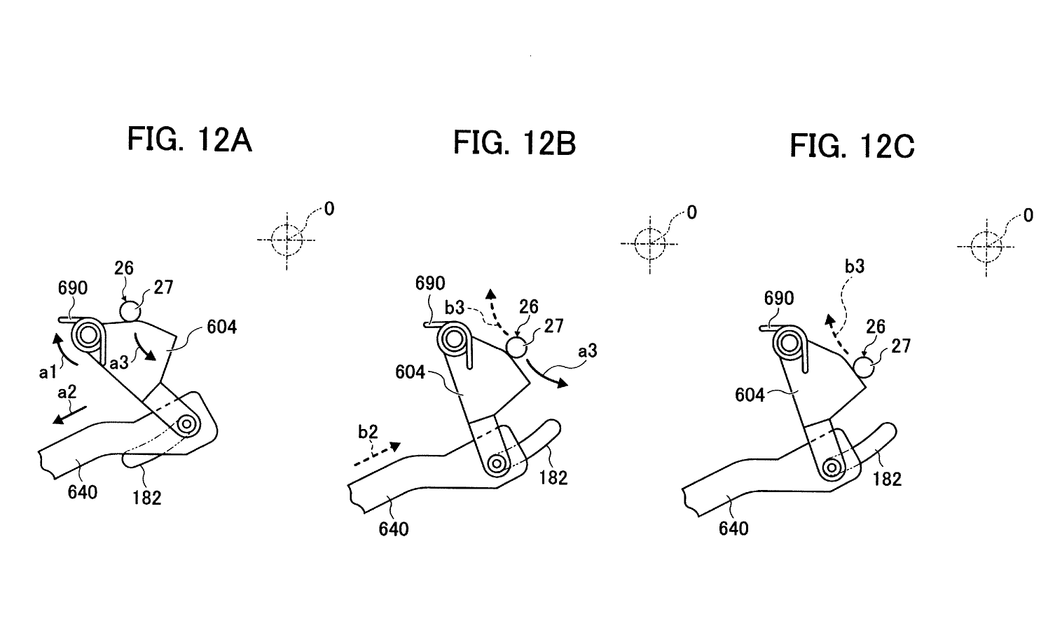

Movement of the rotating member 604 and the moving member 640 is illustrated in detail in FIGS. 12A to 12C. In conjunction with closing of the main opening/closing part 26, the push portion 27 formed in the main opening/closing part 26 rolls about the center of rotation O in a direction of arrow a3 from its position as shown in FIG. 12A to its position as shown in FIG. 12B and eventually to its position as shown in FIG. 12C. When the push portion 27 rolls from its position as shown in FIG. 12A to its position as shown in FIG. 12B, the rotating member 604 rotates in the direction of arrow a1 and the moving member 640 moves in the direction of arrow a2.

However, while the push portion 27 further moves from its position as shown in FIG. 12B to its position as shown in FIG. 12C by closing the main opening/closing part 26, the rotating member 604 does not rotate and the moving member 640 does not move. That is, during closing of the main opening/closing part 26, at a stage when the main opening/closing part 26 has been closed up to a certain angle, the rotation of the rotating member 604 and the movement of the moving member 640 are stopped. Closing exceeding the certain angle will no longer rotate the rotating member 604 and thus the moving member 640 will no longer move.

When the main opening/closing part 26 is opened from the closed state with respect to the image forming apparatus main body 12, the push portion 27 rolls about the center of rotation O in a direction of arrow b3 from its position as shown in FIG. 12C to its position as shown in FIG. 12B and eventually to its position as shown in FIG. 12A. While the push portion 27 moves from its position as shown in FIG. 12C to its position as shown in FIG. 12B, neither the rotating member 604 nor the moving member 640 moves. However, when the push portion 27 moves from its position as shown in FIG. 12B to its position as shown in FIG. 12A, the rotating member 604 rotates in the direction of arrow b1 and the moving member 640 moves in the direction of arrow b2. That is, during opening of the main opening/closing part 26, the rotating member 604 does not rotate and the moving member 640 does not move until the main opening/closing part 26 has been opened up to a certain angle, but further opening of the main opening/closing part 26 exceeding the certain angle triggers the rotation of the rotating member 604 and the movement of the moving member 640.

The position of the main opening/closing part 26 causing the stop of the rotation of the rotating member 604 and the movement of the moving member 640 during closing of the main opening/closing part 26 corresponds to the position of the main opening/closing part 26 triggering the rotation of the rotating member 604 and the movement of the moving member 640 during opening of the main opening/closing part 26. This position of the main opening/closing part 26 causing the stop of the rotation of the rotating member 604 and the movement of the moving member 640 and triggering the rotation of the rotating member 604 and the movement of the moving member 640 can be determined arbitrarily by altering the shape of a portion of the rotating member 604 to contact the push portion 27.

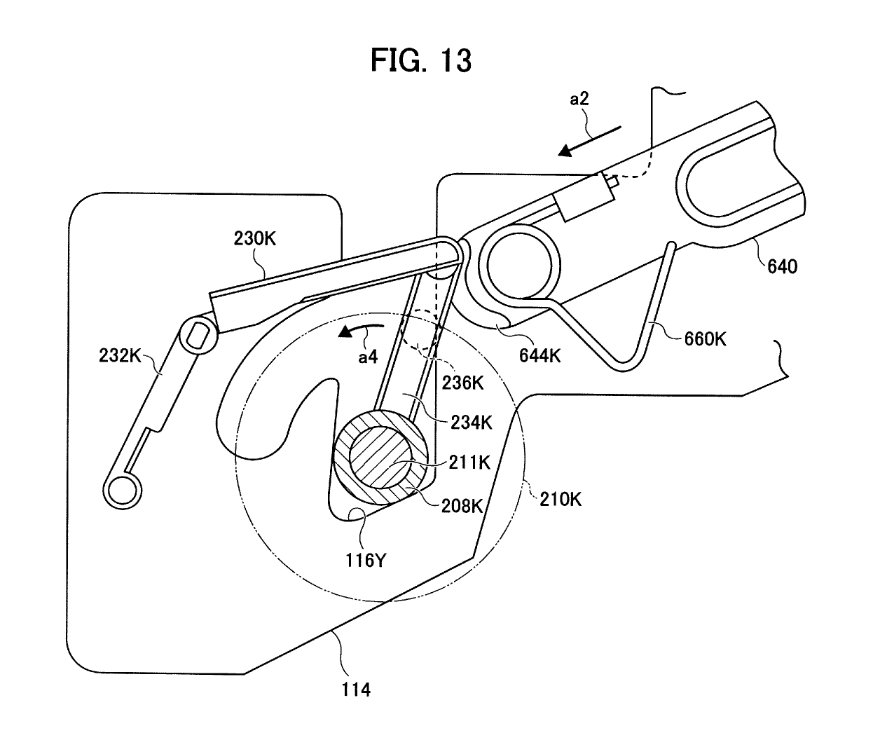

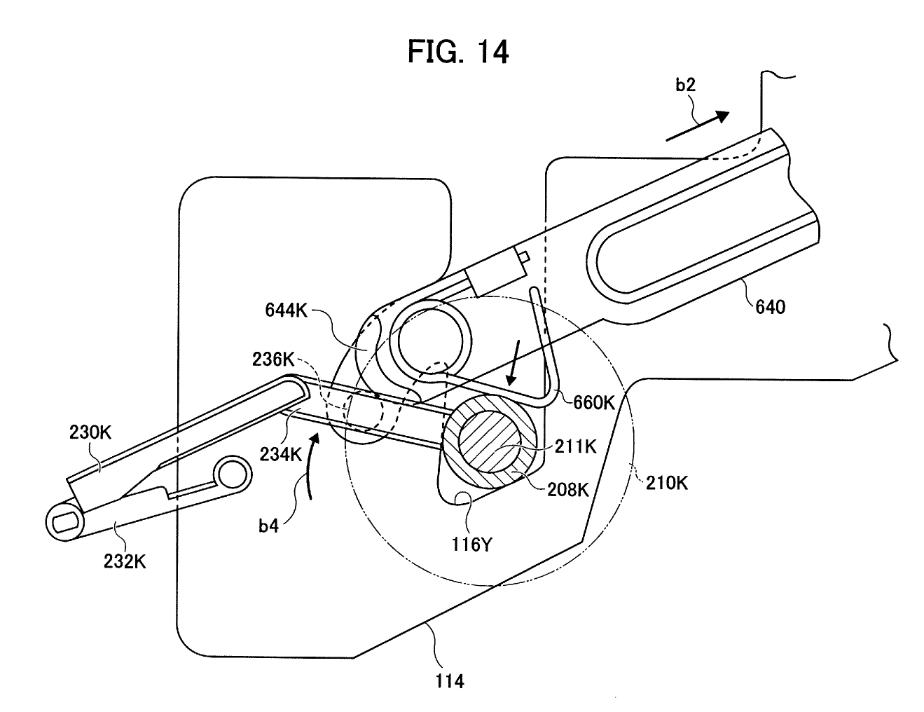

Enlarged views of the vicinity of a position where a push protrusion 644K of the moving member 640 is provided are shown in FIG. 13 and FIG. 14.

When the main opening/closing part 26 is closed with respect to the image forming apparatus main body 12, the moving member 640 moves in a direction of arrow a2 shown in FIG. 13 from its position as shown in FIG. 13 to its position as shown in FIG. 14. When the moving member 640 moves in the direction of arrow a2, the push protrusion 644K comes in contact with a pushed protrusion 236K and pushes the pushed protrusion 236K. Since the pushed protrusion 236K is pushed by the push protrusion 644K, the pushed member 234K rotates in a direction of arrow a4 shown in FIG. 13. In conjunction with the rotation of the pushed member 234K in the direction of arrow a4, the shutter member 230K moves from its protective position over the photoreceptor drum 210K as shown in FIG. 13 to its moved-aside position beside the photoreceptor drum 210K as shown in FIG. 14.

When the pushed protrusion 236K is pushed by the push protrusion 644K, the pushed protrusion 236K rotates about the shaft portion 211K of the photoreceptor drum 210K, as the center of rotation, and enters the arc-shaped branch notch 118K branching from the main notch 116K. By being further pushed by the push protrusion 644K, the pushed protrusion 236K is pushed against the bottom of the branch notch 118K. Thereby, the shutter member 230K is held in the moved-aside position beside the photoreceptor drum 210K.

Then, the movement of the shutter member 230K to the moved-aside position is stopped at a stage when the main opening/closing part 26 has been closed up to a certain angle, because the movement of the moving member 640 is stopped at the stage when the main opening/closing part 26 has been closed up to the certain angle during closing of the main opening/closing part 26, as described above.

Furthermore, when the main opening/closing part 26 is closed with respect to the image forming apparatus main body 12 and the moving member 640 moves in the direction of arrow a2, the spring 660K comes in contact with the bearing 208K fixed to the photoreceptor drum 210K and pushes the bearing 208K into the main notch 116 formed in the left attachment plate 114. Since the bearing 208K is thus pushed and fit in the left attachment plate 114, the photoreceptor drum 210K is positioned with respect to the left attachment plate 114 and the corresponding photoreceptor unit 200 is positioned with respect to the left attachment plate 114.

Then, the positioning of the photoreceptor drum 210K with respect to the left attachment plate 114 and the positioning of the corresponding photoreceptor unit 200 with respect to the left attachment plate 114 are completed at a stage when the main opening/closing part 26 has been closed up to a certain angle, because the movement of the moving member 640 is stopped at the stage when the main opening/closing part 26 has been closed up to the certain angle during closing of the main opening/closing part 26, as described above.

On the other hand, when the main opening/closing part 26 is opened with respect to the image forming apparatus main body 12, the moving member 640 moves in a direction of arrow b2 shown in FIG. 14 from its position as shown in FIG. 14 to its position as shown in FIG. 13. When the moving member 640 moves in the direction of arrow b2, the pushed member 234K is urged by the urging member (not shown) and rotates in a direction of arrow b4 shown in FIG. 14. In conjunction with the rotation of the pushed member 234K in the direction of arrow b4, the shutter member 230K moves from its moved-aside position beside the photoreceptor drum 210K shown in FIG. 14 to its protective position over the photoreceptor drum 210K shown in FIG. 13.

As described above, the movement of the moving member 640 is triggered at a stage when the main opening/closing part 26 has been opened up to a certain angle during opening of the main opening/closing part 26. Hence, the movement of the shutter member 230K to the protective position is also triggered at the stage when the main opening/closing part 26 has been opened up to the certain angle.

Furthermore, when the main opening/closing part 26 is opened with respect to the image forming apparatus main body 12 and the moving member 640 moves in the direction of arrow b2, the spring 660K is detached from the bearing 208K fixed to the photoreceptor drum 210L and the bearing 208K pushed by the spring and fit in the main notch 116 formed in the left attachment plate 114 is released. As described above, the movement of the moving member 640 is triggered at a stage when the main opening/closing part 26 has been opened up to a certain angle during opening of the main opening/closing part 26. Hence, the bearing 208K pushed by the spring and fit in the main notch 116 formed in the left attachment plate 114 is released at the stage when the main opening/closing part 26 has been opened up to the certain angle.

The preceding paragraphs have explained that the shutter member 230K in the photoreceptor unit 200K is opened and closed and the photoreceptor drum 210K is mechanically pushed and fit in and released from the left attachment plate 114 in conjunction with opening and closing of the main opening/closing part 26. Likewise, the shutter members 230Y, 230M, 230C respectively included in the photoreceptor units 200Y, 200M, 200C are also opened and closed in conjunction with opening and closing of the main opening/closing part 26. The photoreceptor drums 210Y, 210M, 2100 are also mechanically pushed and fit in and released from the left attachment plate 114 in conjunction with opening and closing of the main opening/closing part 26.

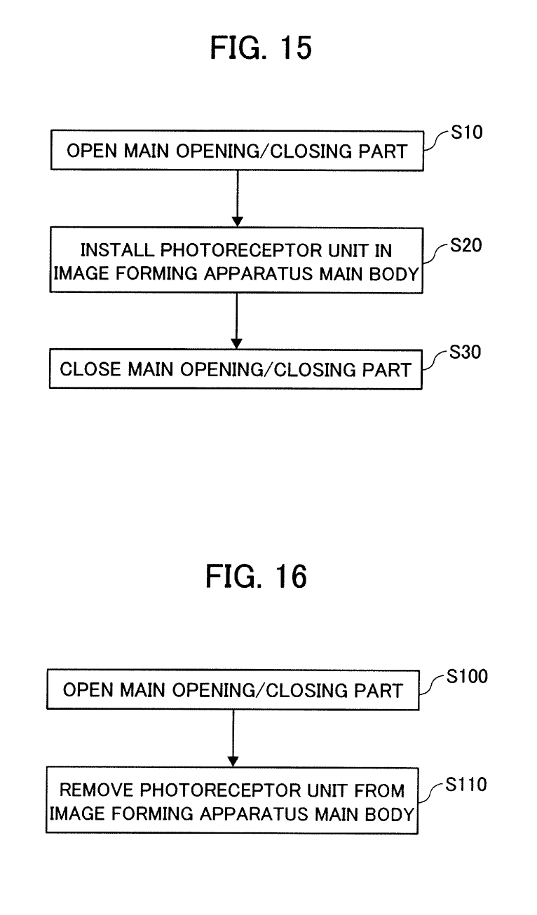

A method for installing at least one of the photoreceptor units 200Y, 200M, 200C, 200K in the image forming apparatus main body 12 is described in FIG. 15. As is outlined in FIG. 15, the main opening/closing part 26 is opened at step S10, thereby opening the open space 36 in the image forming apparatus main body 12.

At the next step S20, at least one of the photoreceptor units 200Y, 200M, 200C, 200K is inserted through the open space 36 and installed in the image forming apparatus main body 12.

At the next step S30, the main opening/closing part 26 is closed with respect to the image forming apparatus main body 12. In conjunction with the closing of the main opening/closing part 26, the shutter member 230 moves from its protective position over the photoreceptor drum 210 to the moved-aside position beside the photoreceptor drum 210. Also in conjunction with the closing of the main opening/closing part 26, the photoreceptor unit 200 is mechanically pushed and fit in the right attachment plate 110 and the left attachment plate 114 in the image forming apparatus main body 12.

A method for removing at least one of the photoreceptor units 200Y, 200M, 200C, 200K from the image forming apparatus main body 12 is illustrated in FIG. 16. As is outlined in FIG. 16, the main opening/closing part 26 is opened at step S100, thereby opening the open space 36 in the image forming apparatus main body 12.

In conjunction with the opening of the main opening/closing part 26, the shutter members 230Y, 230M, 230C, 230K respectively included in the photoreceptor units 200Y, 200M, 200C, 200K moves from the moved-aside position beside the photoreceptor drum to the protective position over the photoreceptor drum. Also in conjunction with the opening of the main opening/closing part 26, the photoreceptor units 200Y, 200M, 200C, 200K mechanically pushed and fit in the right attachment plate 110 and the left attachment plate 114 in the image forming apparatus main body 12 are released.

Then, at the next step 110, at least one of the photoreceptor units 200Y, 200M, 200C, 200K is removed from the image forming apparatus main body 12 through the open space 36 provided in the image forming apparatus main body 12 by opening the main opening/closing part 26.

As explained hereinbefore, the present invention can be applied to an image forming apparatus such as, for example, copiers, printers, and facsimile equipment, and to a method for installing an image forming structure in such image forming apparatus, and a method for removing an image forming structure from the above image forming apparatus.

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes that come within the meaning and range of equivalency of the claims are to be embraced within their scope.

What is claimed is:

1. An image forming apparatus comprising:
an image forming apparatus main body;
an opening/closing part provided in the image forming apparatus main body;
an image forming structure including an image holder that holds an image and an image holder covering member that moves between a protective position over the image holder and a moved-aside position beside the image holder, the image forming structure being installed and removed in/from the image forming apparatus main body through an open space which is opened by opening the opening/closing part;
a displacement mechanism that moves the image holder covering member to the protective position in conjunction with opening of the opening/closing part and moves the image holder covering member to the moved-aside position in conjunction with closing of the opening/closing part; and
a push mechanism that releases the image forming structure mechanically pushed and fit in the image forming apparatus main body in conjunction with opening of the opening/closing part and pushes the image forming structure to be fit in the image forming apparatus main body in conjunction with closing of the opening/closing part.

2. The image forming apparatus according to claim 1, wherein the push mechanism releases the image holder mechanically pushed and fit in the image forming apparatus main body in conjunction with opening of the opening/closing part and pushes the image holder to be fit in the image forming apparatus main body in conjunction with closing of the opening/closing part.

3. The image forming apparatus according to claim 1, wherein the displacement mechanism triggers movement of the image holder covering member to the protective position once the opening/closing part has been opened up to a predetermined angle position and completes movement of the image holder covering member to the moved-aside position beside the image holder until the opening/closing part is closed up to the predetermined angle position.

4. The image forming apparatus according to claim 1, wherein the push mechanism triggers releasing of the image forming structure mechanically pushed and fit in the image forming apparatus main body once the opening/closing part has been opened up to a predetermined angle position and completes pushing the image forming structure to be fit in the image forming apparatus main body until the opening/closing part is closed up to the predetermined angle position.

5. The image forming apparatus according to claim 1, wherein a plurality of image forming structures are installed and removed in/from the image forming apparatus main body and the image forming apparatus main body includes bracket members for the plurality of image forming structures to be pushed and fit therein.

6. A method for installing an image forming structure, the method comprising:
opening an opening/closing part hinged to an image forming apparatus main body, thereby opening an open space;
installing the image forming structure including an image holder that holds an image and an image holder covering member that moves between a protective position over the image holder and a moved-aside position beside the image holder in the image forming apparatus main body through the open space; and
closing the opening/closing part, moving the image holder covering member to the moved-aside position in conjunction with closing of the opening/closing part, and pushing the image forming structure to be fit into the image forming apparatus main body in conjunction with closing of the opening/closing part.

7. A method for removing an image forming structure that includes an image holder that holds an image and an image holder covering member that moves between a protective position over the image holder and a moved-aside position beside the image holder, the method comprising:
opening an opening/closing part hinged to an image forming apparatus main body, moving the image holder covering member to the protective position in conjunction with opening of the opening/closing part, and releasing the image forming structure pushed and fit in the image forming apparatus main body in conjunction with opening of the opening/closing part; and
removing the image forming structure from the image forming apparatus main body through an open space opened by opening the opening/closing part.
